(19) United States
(12) Patent Application Publication
(10) Pub. No.: US 2020/0162789 A1
(43) Pub. Date: May 21, 2020

(54) Method And Apparatus Of Collaborative Video Processing Through Learned Resolution Scaling

(71) Applicants: Zhan Ma, Fremont, CA (US); Ming Lu, Nanjing (CN)

(72) Inventors: Zhan Ma, Fremont, CA (US); Ming Lu, Nanjing (CN)

(21) Appl. No.: 16/688,786

(22) Filed: Nov. 19, 2019

Related U.S. Application Data
(60) Provisional application No. 62/769,550, filed on Nov. 19, 2018.

(51) Int. Cl. H04N 21/4402; H04N 21/437; H04N 21/2343; G06T 3/40

(52) U.S. Cl. CPC H04N 21/440263; G06T 3/4046; H04N 21/234363; H04N 21/437

(57) ABSTRACT

In a collaborative video processing method and system, a high resolution video input is optionally downscaled to a low resolution video using a down-sampling filter, followed by an end-to-end video coding system to encode the low resolution video for streaming over the Internet. The original high resolution is obtained at the client end by upscaling the low resolution video using a deep learning based high resolution scaling model, which can be trained in a pre-defined progressive order with low resolution videos having different compression parameters and downscaling factors.

### CROSS-REFERENCE TO RELATED APPLICATIONS

This application claims priority to the following patent application, which is hereby incorporated by reference in its entirety for all purposes: U.S. Patent Provisional Application No. 62/769550, filed on Nov. 19, 2018.

### TECHNICAL FIELD

This invention relates to collaborative video processing, particularly methods and systems using deep neural networks for processing networked video.

### BACKGROUND

Networked video applications become prevailing in our daily life, from live streaming, such as YouTube and Netflix, to online conferencing such as FaceTime and WeChat Video, to cloud gaming such as GeForce Now. At the same time, the requirement for high video quality becomes highly desired for these applications. The high resolutions (“HR”) of 2k or 4k, even the ultra-high resolution of 8k, are demanded, instead of the 1080p standard resolution that became available just a few years ago. But transmission of such high-resolution videos requires increased network bandwidth, which is often limited and very expensive.

How to efficiently transmit videos at high resolutions with least bandwidth needed is a vital consideration in developing networked video applications. A possible solution is to encode the videos using a newly developed and advanced video coding standard, for example using HEVC instead of H.264/AVC. But promotion and adoption of a new coding standard usually takes time. Even though HEVC was finalized in 2012, H.264/AVC standardized in 2003n still dominates the video industry and is expected to stay in use for a long time.

Reducing bitrate of transmitting the compressed video may also be achieved by increasing the degree of quantization or reducing the resolution, but at the cost of reducing video quality. Traditional deblocking or up-sampling filters (e.g., bicubic) usually smooth the images, causing quality degradation.

In addition to aforementioned methods to reduce bitrate of video transmission, recently, deep learning is introduced to improve the video resolution at reduced transmission bitrates. For example, neural-mode-based deep learning is used to learn the mapping models between the original high resolution and downscaled low resolution videos. Learned algorithms are used to restore the HR representations as much as possible, often yielding better visual quality than the conventional schemes. However, such algorithms are usually used against data without compression noise.

### BRIEF SUMMARY

The present invention provides a real-time collaborative video processing method based on deep neural networks (DNNs), referred to hereafter as CVP, which provides an innovative solution built on the conventional video codecs and deep-learning-based super resolution methods to improve the coding efficiency without sacrifice of the visual quality.

The CVP system includes a spatial down-sampling module, a video coding and streaming module, a color transform module, and a learned resolution scaling module.

In one embodiment, the down-sampling module is applied to downscale a high resolution (HR) video input to a low resolution (LR) alternative. Common down-sampling filters (e.g., bicubic, etc.) can be adopted. In another embodiment, the CVP system could directly capture videos at a low resolution.

In one embodiment, the downscaling factor (e.g., 2×/3×/4× for both horizontal and vertical directions) is content-aware. This factor is determined by computing the spatial perceptual information (SI) and temporal perceptual information (TI) to explore the resolution redundancy. By setting specific threshold values of SI and TI for different resolutions, which can be derived from testing a range of different SI and TI values for different content, the downscaling factor that is oversampled can be screened out to avoid excessive loss of information for the upcoming reconstruction.

In one embodiment, the video codec (i.e., H.264/HEVC/AV1) is applied at the video coding module to encode the LR video at the sender server. The encoded bit stream is then encapsulated and delivered to the client across the internet.

In another embodiment, a deep learning based super resolution method is used in the learned resolution scaling module to restore the HR representation before display rendering at the client.

In one embodiment, bitrate and perceptual quality of a compressed video are determined by its spatial resolution (which depends on the down-sampling factor) and quantization parameter (or compression parameters). Given the limited network bandwidth for transmission of compressed videos, several combinations of down-sampling factors and compression parameters (e.g., quantization profiles at 17, 22, 27, 32) are considered and tested to derive the optimal bitrate that meets the bandwidth constraint and offers the best video quality.

In one embodiment, the pre-trained super resolution model for each combination of a specific down-sampling factor and a specific compression parameter is sent from the content server (e.g. an edge server, or a content provider's server) to the client for learned resolution scaling of a video with that down-scaling factor and compression parameter. When the video scene and content changes, a different pretrained learned resolution scaling model will be used to adapt for the new video scene or content that have a different downscaling factor or a different compression parameter. In a further embodiment, where the client has limited resources, instead of transmitting a new model to the client from the server, the difference between the new model and the last used model is computed and then transmitted to the client for updates.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 is a block diagram that illustrates an example of a CVP system.

FIG. 2 is a diagram that shows an example of the learned resolution scaling network.

FIG. 3 is a diagram that shows an example of Residual Block basic unit for building an exemplary learned resolution scaling network.

FIG. 4 is a diagram that shows the sub-pixel shuffle layer for up-sampling the feature maps.

FIG. 5 is a diagram that shows an example of generating training datasets.

FIG. 6 is a diagram that illustrates the signaling for delivering pretrained learned resolution scaling models between the content server and the user client.

FIG. 7 is a diagram illustrating various components that may be utilized in an exemplary embodiment of the electronic devices wherein the exemplary embodiment of the present principles can be applied.

### DETAILED DESCRIPTION

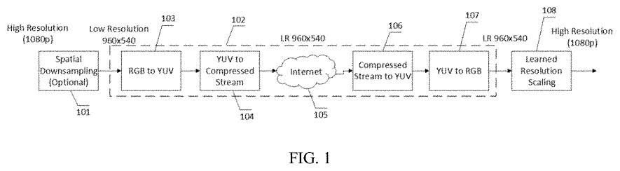

FIG. 1 illustrates an exemplary CVP system of the present principles. A spatial down-sampling filter 101 is optionally applied to downscale a high resolution video input to a low resolution representation. Alternatively, a low resolution video can be directly captured instead of being converted from a high resolution version. High resolution video, such as 1080p shown in FIG. 1, can be obtained from a camera, or a graphical processing unit buffer. A typical down-sampling filter can be bilinear, or bicubic, or even convolutional based. An end-to-end video coding system 102 is then utilized to encode the low resolution video, including color space transform (e.g., from RGB to YUV) 103, video encoding using compatible codec 104 (e.g., from YUV source to binary strings), streaming over the Internet 105, and corresponding video decoding 106 (e.g., from binary strings to YUV sources), and color space inverse transform (e.g., from YUV to RGB prior to being rendered) 107. Downscaling factor of 4, e.g., 2× for both horizontal and vertical directions to a low resolution of 960×540, is illustrated in FIG. 1. Other scaling factors are applicable as well. Low resolution video frames are then upscaled to high resolution before being rendered to the display via learned resolution scaling 108 (e.g., from 960×540 to 1080p). A deep learning-based resolution scaling is employed in 108 to process decoded LR video and to restore the high resolution representation without impairing the visual quality.

Different codecs, including video coding standard-compliant codecs, can be applied in 102 in this CVP system to encode low resolution videos for streaming. Codec operations could follow the procedures defined in the standard, such as using bandwidth constrained bit rate adaptation. Learned resolution scaling 108 is shown in the RGB color space. It can be extended to other color spaces (e.g., YUV) as well, which depends on the application requirements and implementation costs.

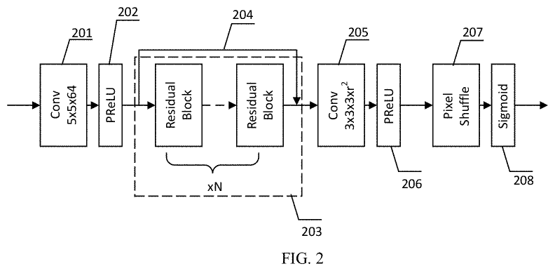

FIG. 2 illustrates learned resolution scaling 108 using a convolutional neural network based super resolution method. Decoded LR video is first processed using a convolutional layer 201. One example of this convolutional layer 201 uses a convolution with a kernel size of 5-by-5 to generate feature maps with 64 channels. Different convolutional kernel sizes and numbers of feature map channels can be used as well. An activation function (e.g. PReLU (Parametric Rectified Linear Unit) 202) is applied after that to perform the non-linear activations. Several Residual Blocks 203 are cascaded together with a residual link 204 to construct a deep network for efficient feature representation and information exploration. Another convolutional layer 205 with a kernel size of 3×3 is applied to generate feature maps with 3×r² channels (e.g., r denotes the up-scaling factor), followed by another activation layer PReLU 206 to increase the nonlinearity of network. A sub-pixel shuffle layer 207 is then applied to upscale the LR feature maps to the HR ones. The output video is then obtained after applying another activation layer Sigmoid 208.

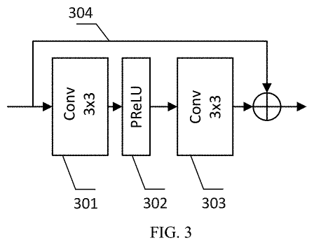

An exemplary Residual Block 203 is further illustrated in FIG. 3, which serves as the basic network unit to aggregate information for efficient high resolution scaling. The total number of the Residual Blocks in 108, e.g., annotated as “×N” in FIG. 2, varies depending on the up-sampling ratios as well as the processing latency requirement. An exemplary residual block can have a processing branch that contains a convolutional layer 301 with a kernel size of 3×3 as an example, a PReLU layer 302, and another convolutional layer 303; and a residual link 304 that will be element-wisely summed up with the processing branch for output generation.

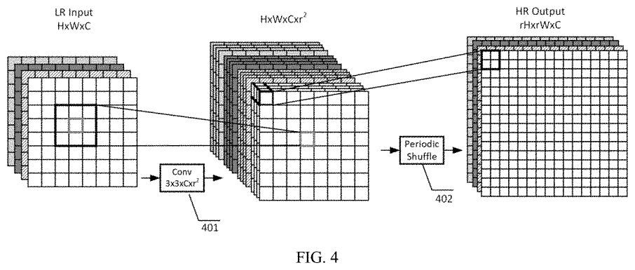

A sub-pixel shuffle layer 207 for a CVP system, which is used to up-scale the LR feature maps to the HR representations, is further illustrated in FIG. 4. The sub-pixel shuffle layer is shown in 402 in FIG. 4. Specifically, LR feature maps have a size of H×W×C, where H denotes the height, W denotes the width, and C denotes the total number of channel of the LR feature maps. A convolutional layer 401 is utilized to generate features with C×r² channels, which is the same as the convolutional layer 205 illustrated in FIG. 2. The HR feature maps are then obtained by periodic shuffling operator 402 that rearranges the elements of a H×W×C×r² tensor to a tensor having a size of rH×rW×C.

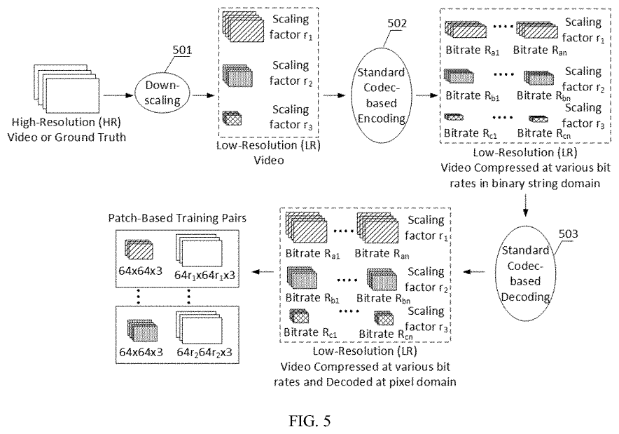

Training is applied to derive appropriate parameters in the learned resolution scaling module 108 of a CVP system. Supervised learning is used in training, which requires training samples to be prepared in advance. As shown in FIG. 5, the original sample videos in the pixel domain, which are also referred to as the “ground truth” or HR videos, are first down-scaled with different down-sampling ratios rs in 501 into low-resolution LR videos. The same scaling factor r is applied to both horizontal and vertical directions for as an example of simplified implementation. But different scaling factors can be applied to the horizontal and vertical directions respectively in different implementation designs. Standard-compliant video codec (e.g., H.264, HEVC) 502 can be used to encode the down-scaled LR videos with different compression ratios (i.e., Quantization Parameters at 22, 27, 32, 37, 42 for example) to generate compressed videos at different bitrates. Compressed videos are then decoded at 503 to construct the training and validation datasets, together with the original HR videos labeled as ground truth. To avoid running out of memory in the GPU and for fast processing, each decoded frame of the dataset can be cropped into patches with a size of 64×64×c (i.e., c=3 for the RGB color space, c=1.5 for the YUV420 color space, other color spaces can have different values for c), and the original HR video likewise can be cropped into similar patches with a size of 64r×64r×c (e.g., 64r represents 64 times the downscaling factor used for that dataset) to form a training repair. Other patch sizes for cropping can be used as well, depending on the GPU capability and the application requirements. Note that for different scaling factors rs, and for different bitrates, the learned resolution scaling model can be different.

The learned resolution scaling module 108 in CVP system is trained in a predefined progressive order. At a given scaling ratio, models having higher quantization parameters (e.g., having higher compression ratios with lower bitrates) are trained using the parameters output from models having lower quantization parameters that are trained before the models having higher quantization parameters gets trained. Such progressive training order leads to faster convergence of quantization parameters and better training results than training the models having different quantization parameters in a different order or independently.

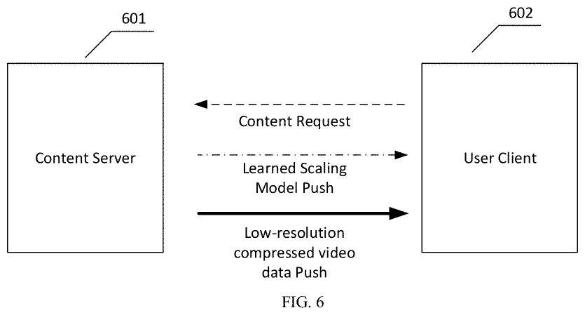

In a further embodiment, as shown in FIG. 6, learned resolution scaling models and compressed video data are cached in a content server 601. Upon receiving a request for a video content from a user client 602, the content server first pushes all models trained for different bitrates and scaling factors to the user client before delivering the compressed video data to the user client. These model parameters can be encapsulated as the metadata and cached with the compressed video data.

In another embodiment, given the limited resource, such as memory capacity, computing power, the user client could not cache all the training models received from the content server. These received models can be simplified by clustering them into several categories. For example, starting from the model M (R₀, r₀) that is trained at the lowest bitrate R₀ and lowest scaling factor r₀, if the model M (R₁, r₀) trained at R₁ and r₀, or the model M(R₀, r₁) trained at R₀ and r₁, offers rate-distortion efficiency close to the M(R₀, r₀), these models will be merged into the M(R₀, r₀) model cluster. Such clustering is conducted iteratively to cover all available models trained at various bitrates and scaling factors, resulting in fewer numbers of model clusters that can be easily cached at resource-limited clients, such as mobile devices.

In one embodiment, the difference in rate-distortion efficiency between two trained models is calculated by measuring the difference between the qualities of videos reconstructed from two trained models. For example, the compressed video downscaled at downscaling factor r₀and encoded at bitrate R₁ will be upscaled using its default model M(R₁, r₀) at the client. The quality of this upscaled video can be measured by PSNR, SSIM or perceptual metrices as Q. In applying the model clustering, the training model M(R₀, r₀) produces a scaled video having a quality measured at Q*. Here, the absolute difference |Q*−Q|Q need to be less than a threshold T, which is defined to control the clustering granularity. Depending on the value of T, the number of trained models to be clustered varies. For example, if T is set to a relatively large number, such as 0.3, more models would be clustered. If T is set to a smaller number, such as 0.01, fewer models will be clustered together.

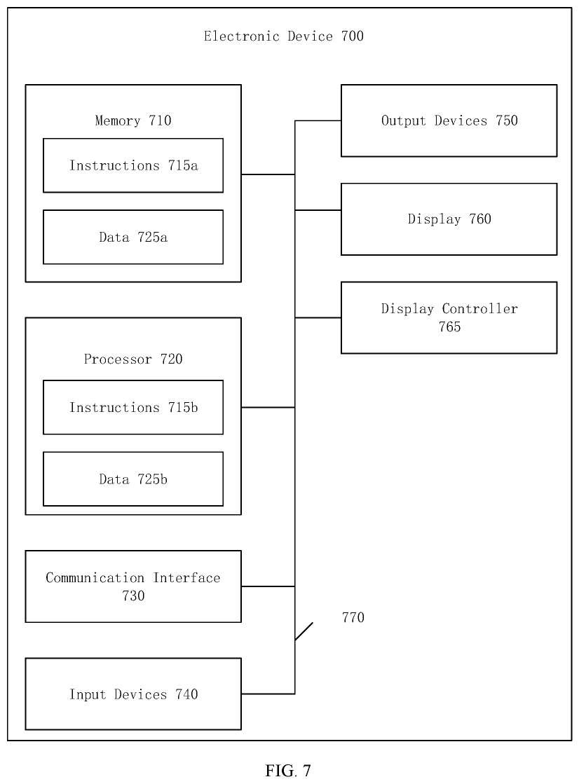

FIG. 7 illustrates various components that may be utilized in an electronic device 700. The electronic device 700 may be implemented as one or more of the electronic devices described previously (such 601 and 602) and may be also implemented to practice the methods and functions (such as 101, 102, 108, FIGS. 1-6) described previously.

The electronic device 700 includes at least a processor 720 that controls operation of the electronic device 700. The processor 720 may also be referred to as a CPU. Memory 710, which may include both read-only memory (ROM), random access memory (RAM) or any type of device that may store information, provides instructions 715a (e.g., executable instructions) and data 725a to the processor 720. A portion of the memory 710 may also include non-volatile random access memory (NVRAM). The memory 710 may be in electronic communication with the processor 720.

Instructions 715b and data 725b may also reside in the processor 720. Instructions 715b and data 725b loaded into the processor 720 may also include instructions 715a and/or data 725a from memory 710 that were loaded for execution or processing by the processor 720. The instructions 715b may be executed by the processor 720 to implement the systems and methods disclosed herein.

The electronic device 700 may include one or more communication interfaces 730 for communicating with other electronic devices. The communication interfaces 730 may be based on wired communication technology, wireless communication technology, or both. Examples of communication interfaces 730 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, a wireless transceiver in accordance with 3^{rd} Generation Partnership Project (3GPP) specifications and so forth.

The electronic device 700 may include one or more output devices 750 and one or more input devices 740. Examples of output devices 750 include a speaker, printer, etc. One type of output device that may be included in an electronic device 700 is a display device 760. Display devices 760 used with configurations disclosed herein may utilize any suitable image projection technology, such as a cathode ray tube (CRT), liquid crystal display (LCD), light-emitting diode (LED), gas plasma, electroluminescence or the like. A display controller 765 may be provided for converting data stored in the memory 710 into text, graphics, and/or moving images (as appropriate) shown on the display 760. Examples of input devices 740 include a keyboard, mouse, microphone, remote control device, button, joystick, trackball, touchpad, touchscreen, lightpen, etc.

The various components of the electronic device 700 are coupled together by a bus system 770, which may include a power bus, a control signal bus and a status signal bus, in addition to a data bus. However, for the sake of clarity, the various buses are illustrated in FIG. 7 as the bus system 770. The electronic device 700 illustrated in FIG. 7 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible.

By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods or approaches described herein may be implemented in and/or realized using a chipset, an application-specific integrated circuit (ASIC), a large-scale integrated circuit (LSI) or integrated circuit, etc.

It should be noted that one or more of the methods described herein may be implemented in and/or performed using hardware. For example, one or more of the methods or approaches described herein may be implemented in and/or realized using a chipset, an application-specific integrated circuit (ASIC), a very-large-scale integrated circuit (VLSI) or integrated circuit, etc. Also, CVP can use different types of video codecs (i.e., H.264/HEVC/AV1, etc.), and various video inputs sampled at different color spaces (e.g., RGB, YUV, etc.).

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

1. A system for collaborative video processing, comprising:
a content server hosting video content, said video content comprising one or more high resolution videos;
a user client;
said user client configured to send a request for video content to the content server, comprising a video decoder and a learned resolution scaling module; said request including a request for a high resolution video
said content server comprising an optional down-sampling module configured to downscale the high resolution video requested by the user client to a low resolution video at a downscaling factor, a video encoder configured to encode the low resolution video into a bit stream having a bitrate, said bit stream is encapsulated and transmitted to the user client, said downscaling factor is included in metadata of said bit stream;
wherein upon receiving the bit stream, the user client decodes the bit stream into video frames using the video decoder and upscale said video frames into a high resolution video using said learned resolution scaling module, wherein said learned resolution scaling module comprising one or more convolutional neural models.

2. The system of claim 1 further comprising a device configured to capture a low resolution video as video content, said device including a camera or a graphical rendering device.

3. The system of claim 1, wherein different video content are downscaled using different downscaling factor and encoded into bit streams having different bit rates.

4. The system of claim 1, wherein the video encoder encodes the low resolution video using one or more compression parameters, wherein said one or more compression parameters including quantization parameters.

5. The system of claim 1, wherein said convolutional neural models are trained in a predefined order and using one or more training datasets, said training datasets comprising patches cropped from the video frames and the high resolution video, said predefined order is progressive starting from a low bitrate to a higher bitrate.

6. The system of claim 5, where said convolutional neural models are trained in the content server and the trained conventional neural models are transmitted to the user client

7. The system of claim 6, when the bitrate or resolution of the video content changes, the user client is configured to change the convolutional neural model used for upscaling the video frames.
